(19) United States
(12) Patent Application Publication
(10) Pub. No.: US 2010/0013781 A1
(43) Pub. Date: Jan. 21, 2010

(54) TOUCH KEY MODULE

(75) Inventors: Cheol-Woong Park, Suwon-si (KR); Il-Seob Baek, Yongin-si (KR); Wan-Sang Ryu, Suwon-si (KR); Joo-Hwan Park, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/500,259

(22) Filed: Jul. 9, 2009

(30) Foreign Application Priority Data
Jul. 17, 2008 (KR) 10-2008-0069439

(51) Int. Cl. G06F 3/041

(52) U.S. Cl. 345/173

(57) ABSTRACT

A touch key module of an electronic device is provided. The touch key module includes a Printed Circuit Board (PCB) on which a capacitive touch sensor chip is located and a conductor, located on a surface of the PCB, for detecting contact of the capacitive touch sensor chip.

### PRIORITY

This application claims the benefit under 35 U.S.C. §119(a) of a Korean patent application filed in the Korean Intellectual Property Office on Jul. 17, 2008 and assigned Serial No. 10-2008-0069439, the entire disclosure of which is hereby incorporated by reference.

### BACKGROUND OF THE INVENTION

1. Field of the Invention

The present invention relates to a touch key module of an electronic device. More particularly, the present invention relates to a capacitive touch key module having a reduced manufacturing cost and improved durability.

2. Description of the Related Art:

Touch key modules are used as novel data input units and have replaced conventional mechanical keys. Thus, the touch key modules are widely used for mobile communication devices, various information devices, domestic appliances, and the like.

The touch key modules serve as sub-keys for portable communication terminals, Personal Digital Assistants (PDAs), Ultra Mobile Personal Computers (UMPCs), and Moving Picture Experts Group (MPEG)-1 Audio Layer 3 (MP3) players (MP3Ps). Since the touch key modules may be applicable to various products and implement a luxurious design appearance in the portable communication terminals, application fields in the touch key modules are very broad.

A capacitive touch sensor technology may be applicable to the touch key modules. The capacitive touch sensor technology recognizes and performs a user's command by an input signal generated when a user's finger is in contact with a contact surface (i.e., an electrode surface). In addition, the touch key modules may emit luxurious light from product appearance cases using Light Emitting Diodes (LEDs) and Light Guide Films (LGFs).

FIG. 1 is a schematic view of an electronic device including a conventional touch key module. Referring to FIG. 1, a conventional touch key module serves as an input unit of the electronic device when a touch Flexible Printed Circuit Board (FPCB) including a touch sensor chip and various circuits is connected to a Printed Circuit Board (PCB).

A plurality of assembly processes is performed to manufacture the conventional touch FPCB type key module. Thus, manufacturing costs are increased. That is, the touch FPCB is connected to the PCB using a connector, and a separate bracket for supporting the touch FPCB is required. Moreover, when the conventional touch FPCB type key module includes an LED and an LGF used for implementing an elegant appearance of an input unit, a desirable brightness may be difficult to achieve because the touch FPCB type key module is structurally complicated.

Therefore, a need exists for a touch key module with reduced manufacturing cost and durable structure.

### SUMMARY OF THE INVENTION

An aspect of the present invention is to address at least the above-mentioned problems and/or disadvantages and to provide at least the advantages described below. Accordingly, an aspect of the present invention is to provide a capacitive touch key module with reduced manufacturing costs, superior stability, and an improved mechanism structure.

In accordance with an aspect of the present invention, a touch key module of an electronic device is provided. The touch key module includes a Printed Circuit Board (PCB) on which a capacitive touch sensor chip is located, and a conductor surface-mounted on the PCB for detecting contact of the capacitive touch sensor chip.

In accordance with another aspect of the present invention, an electronic device including a touch key is provided. The touch key module includes a PCB on which a capacitive touch sensor chip is located, and a conductor surface-mounted on the PCB for detecting contact of the capacitive touch sensor chip.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a schematic view of an electronic device including a conventional touch key module;

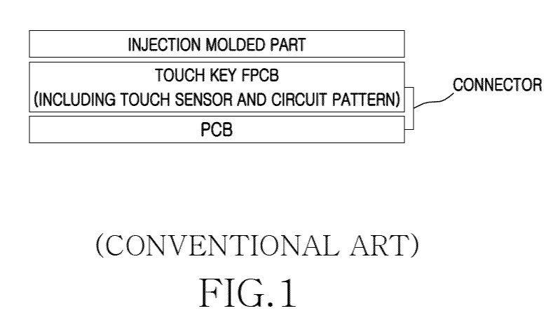

FIG. 2 is a perspective view of a portable terminal according to an exemplary embodiment of the present invention; and

FIG. 3 is a schematic view of an electronic device including a touch key module according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawing is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an inexpensive capacitive touch key module with superior stability and an improved mechanism structure.

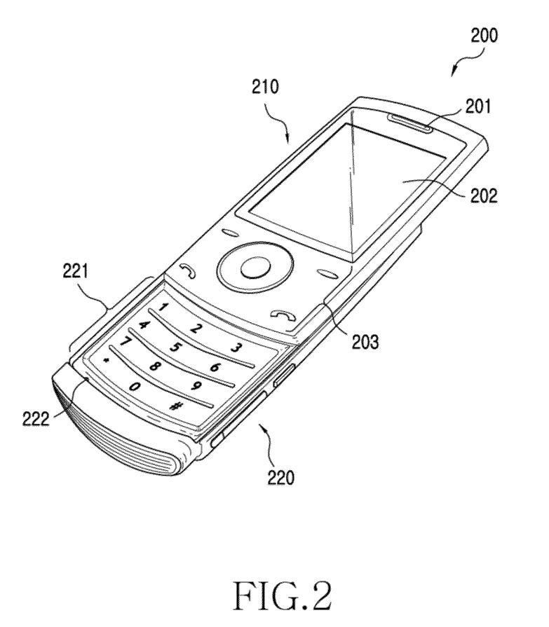

FIG. 2 is a perspective view of a portable terminal according to an exemplary embodiment of the present invention.

FIG. 2 illustrates an exemplary slide type portable terminal. However, the type of terminal is not limited to the slide type. In an exemplary implementation, a variety of portable terminals may be used, such as, a bar type portable terminal, a flip type portable terminal, a folder type portable terminal, a slide and rotation type portable terminal, and the like.

The portable terminal 200 includes a main body 220 and a sub-body 210 slidably coupled to the main body 220. The sub body 210 is capable of sliding on the main body 220 within a certain range in a lengthwise direction, such that the slide type portable terminal 200 may be opened and closed.

A keypad assembly 221, which is a data input unit, is installed on an upper portion of the main body 220. A microphone unit 222 for transmitting a user's voice is installed at a lower side of the keypad assembly 221.

A display unit 202, which is a data output unit, is installed on an upper portion of the sub-body 210. A color wide Liquid Crystal Display (LCD) module of several hundred thousand pixels to several million pixels may be used as the display unit 202. Alternatively, a touch screen that accepts a touch input from a user may be used as the display unit 202. A speakerphone unit 201 for receiving a voice of another party is installed above the display unit 202. Also, a touch key assembly 203, which is a data input unit, is installed under the display unit 202. The touch key assembly 203 uses a capacitive sensor chip that detects charge-redistribution generated when a user's finger has contact with an electrode surface to recognize a user's input.

More specifically, components, such as the capacitive sensor chip, for recognizing an input signal of the touch key and touch recognition circuit patterns corresponding to the components are mounted on a sub-Printed Circuit Board (sub-PCB) (not illustrated) of the sub-body 210.

Moreover, in the capacitive sensor chip, a conductor for detecting the user's touch is mounted on the sub-PCB using a surface mount technology. When the user is in contact with a contact surface of the conductor, the capacitive sensor chip recognizes the user's input through the touch recognition circuit patterns.

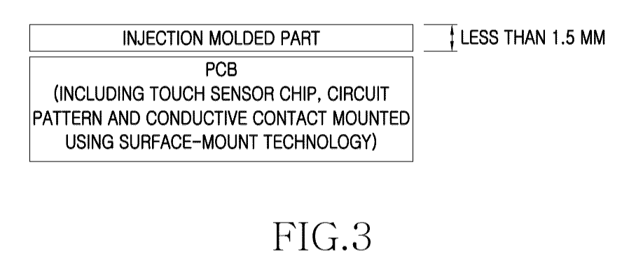

FIG. 3 is a schematic view of an electronic device including a touch key module according to an exemplary embodiment of the present invention.

Referring to FIG. 3, a capacitive sensor chip for recognizing an input signal of a touch key and a touch recognition circuit pattern corresponding to the capacitive sensor chip are located on a PCB. A conductor is also located on the PCB, and the capacitive sensor chip detects user's contact through the conductor.

The capacitive sensor chip detects an input signal according to charge-redistribution generated when an object, such as a user's finger, is in contact with a contact surface (i.e., an electrode surface) of the conductor. In addition, the PCB is fixed to a non-conductive case frame defining an outer appearance of the electronic device. In this case, the capacitive sensor chip may recognize a touch corresponding to direct contact with the contact surface of the conductor or recognize a touch corresponding to indirect contact using the non-conductive case frame as an input medium. In an exemplary implementation, the capacitive sensor chip may recognize the touch according to the indirect touch when the case frame has a thickness of less than about 1.5 mm.

In an exemplary embodiment of the present invention, a capacitive sensor ship and a touch recognition circuit pattern are located on a PCB providing a touch key module with an improved mechanism structure and improved durability. Moreover, manufacturing costs are reduced since an assembly process for manufacturing the touch key module is reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch key module of an electronic device, comprising:
a Printed Circuit Board (PCB) on which a capacitive touch sensor chip is located; and
a conductor, located on a surface of the PCB, for detecting contact of the capacitive touch sensor chip.

2. The touch key module of claim 1, wherein the capacitive touch sensor chip corresponds to a touch recognition circuit pattern.

3. The touch key module of claim 1, wherein the capacitive touch sensor chip recognizes a touch through direct contact with one of a contact surface of the conductor and indirect contact using a non-conductive case frame as an input medium.

4. The touch key module of claim 3, wherein the capacitive touch sensor chip detects the touch according to generated charge-redistribution on the contact surface of the conductor.

5. The touch key module of claim 3, wherein the non-conductive case frame has a thickness of less than about 1.5 mm.

6. An electronic device comprising:
a touch key module comprising a Printed Circuit Board (PCB) on which a capacitive touch sensor chip is located, and a conductor, located on a surface of the PCB, for detecting contact of the capacitive touch sensor chip.

7. The electronic device of claim 6, wherein the capacitive touch sensor chip corresponds to a touch recognition circuit pattern.

8. The electronic device of claim 6, wherein the capacitive touch sensor chip recognizes a touch through direct contact with one of a contact surface of the conductor and indirect contact using a non-conductive case frame as an input medium.

9. The electronic device of claim 8, wherein the capacitive touch sensor chip detects the touch according to generated charge-redistribution on the contact surface of the conductor.

10. The electronic device of claim 8, wherein the nonconductive case frame has a thickness of less than about 1.5 mm.

11. A portable terminal including an electronic device comprising:
a touch key module comprising a Printed Circuit Board (PCB) on which a capacitive touch sensor chip is located, and a conductor, located on a surface of the PCB, for detecting contact of the capacitive touch sensor chip.

12. The portable terminal of claim 11, wherein the capacitive touch sensor chip corresponds to a touch recognition circuit pattern.

13. The portable terminal of claim 11, wherein the capacitive touch sensor chip recognizes a touch through direct contact with one of a contact surface of the conductor and indirect contact using a non-conductive case frame as an input medium.

14. The portable terminal of claim 13, wherein the capacitive touch sensor chip detects the touch according to generated charge-redistribution on the contact surface of the conductor.

15. The portable terminal of claim 13, wherein the nonconductive case frame has a thickness of less than about 1.5 mm.
